(19) United States
(12) Patent Application Publication
(10) Pub. No.: US 2013/0290190 A1
(43) Pub. Date: Oct. 31, 2013

(54) METHOD AND SYSTEM FOR PROVIDING UNIVERSAL ACCESS TO A SERVICE AMONGST A PLURALITY OF SERVICES

(71) Applicants: Johan Maris, Lubbeek (BE); Sam Van Campenhout, Lubbeek (BE); Dirk Verhetsel, Lubbeek (BE)

(72) Inventors: Johan Maris, Lubbeek (BE); Sam Van Campenhout, Lubbeek (BE); Dirk Verhetsel, Lubbeek (BE)

(73) Assignees: PAY & SAVE NV, Lubbeek (BE); John Maris, Lubbeek (BE)

(21) Appl. No.: 13/701,718

(22) PCT Filed: Jun. 8, 2011
(86) PCT No.: PCT/EP2011/059457

§ 371 Date: Jul. 16, 2013

(30) Foreign Application Priority Data
Jun. 8, 2010 (EP) 10165220.4

(51) Int. Cl. G06Q 20/36

(52) U.S. Cl. CPC G06Q 20/363
USPC 705/50

(57) ABSTRACT

A method and system for providing universal access to a service amongst a plurality of services capable of storing a plurality of service accounts, each corresponding to a customer and a service the customer is subscribed to, receiving a request from a customer for using a service, determining a service account upon identification of such customer and the requested service or its service provider, consulting confidential service account content corresponding to the service account, characterized in that consulting the confidential service account content having real-time communicating with the service provider, the service provider providing real-time access to the confidential service account content. The system including means is adapted to communicate real-time with the service provider.

### FIELD OF THE INVENTION

The present invention relates to a method and system for providing universal access to a service amongst a plurality of services.

### BACKGROUND OF THE INVENTION

Currently, customers collect a large number of loyalty cards, bank cards, credit cards, badges, and other identification instruments associated with all kinds of services they are subscribed to such as bank accounts, loyalty program accounts, etc.

A known general problem is that it is difficult to maintain such large number of cards and either to continuously carry them all in a handbag or a wallet, either to make sure having the correct valid card available upon using a service or visiting a store or a bank.

In an attempt to overcome the above problem, US 2010/0042517 describes a method for providing universal access to loyalty program accounts and/or financial accounts. Further, the patent application describes a uniform loyalty program account device to access a plurality of loyalty accounts and/or financial accounts. The device includes a storage mechanism configured to store account information for loyalty program accounts and/or financial accounts.

However, a disadvantage of the above method and device is that the collection of service accounts and corresponding account information is stored on a central server, which consequently implicates that the service provider has to share confidential service account content with the universal access system. Most service providers are not keen to do so for privacy and security reasons.

Another disadvantage of the above method and device is that service account content has to be duplicated in the universal access system database from the service provider's database, which in fact means a waste of memory space.

A further disadvantage is that, since duplication of the service account content is performed with a certain frequency, provisions have to be made to avoid situations wherein a customer intends to use a service of which the service account content is not yet up-to-date.

Still another disadvantage of known methods and systems is that a dedicated universal identification instrument, e.g. a dedicated ID card, has to be released which the customer needs to have with him every time he wants to make use of a service.

Considering the above, as a first object the present invention provides a method and system for providing universal access to a service amongst a plurality of services, wherein confidential service account content does not need to be shared with the universal access system, resulting in less or even minimized privacy and security problems.

It is another object of the present invention to provide a method and system for providing universal access to a service amongst a plurality of services, wherein service account content does not need to be duplicated such that memory space is saved.

Further it is an object of the present invention to provide a method and system for providing universal access to a service amongst a plurality of services, having the ability to deliver the customer and the service provider up-to-date service account content.

Another object of the present invention is to provide a method and system where no additional dedicated universal identification instrument has to be released and where a customer is not dependent on carrying that dedicated universal identification instrument with him every time he wants to make use of a service.

An additional object of the present invention is to provide a method and system for providing universal access to a service amongst a plurality of services, allowing easy implementation of business intelligence applications.

The present invention meets the above objects by consulting confidential service account content via real-time communication with the service provider, wherein the service provider provides real-time access to said confidential service account content.

### SUMMARY OF THE INVENTION

The present invention is directed to a method for providing universal access to a service amongst a plurality of services comprising:
storing a plurality of service accounts, each corresponding to a customer and a service said customer is subscribed to,
receiving a request from a customer for using a service,
determining a service account upon identification of such customer and the requested service or its service provider,
consulting confidential service account content corresponding to said service account,
   characterized in that consulting said confidential service account content comprises real-time communicating with said service provider, said service provider providing real-time access to said confidential service account content.

Additionally the present invention is directed to a system for providing universal access to a service amongst a plurality of services comprising:
a means for storing a plurality of service accounts, each corresponding to a customer and a service said customer is subscribed to,
a determination means for determining a service account upon identification of such customer and the requested service or its service provider,
a consulting means for consulting confidential service account content corresponding to said service account,
   characterized in that said consulting means is adapted to communicate real-time with said service provider, said service provider providing real-time access to said confidential service account content.

### BRIEF DESCRIPTION OF THE DRAWINGS

FIG. 1 illustrates an embodiment of a method and system in accordance with the present invention.

FIG. 2 illustrates another embodiment of a method and system in accordance with the present invention.

FIG. 3 illustrated a multi-role loyalty program in accordance with the present invention.

### DESCRIPTION OF THE INVENTION

In the context of the present invention, the service amongst a plurality of services may be any kind of service where customers may be subscribed to such as banking services, loyalty programs, warranty services, rental services, pre-payment services, coupon services, ticketing services, health care services, governmental services, etc.

Further in the context of the present invention, a customer is to be understood as not only an individual, but also as a group of people, such as a family, a club, a society, a company, etc. intending to make use of a service as described above.

Further, a service provider has to be understood as a supplier providing a service as described above.

In the context of the present invention, confidential service account content is to be understood as any content of a service account which may not be disclosed without authorization from the customer, the service provider, the government, etc. for reasons of privacy, security, or any other reason.

According to a first embodiment of the present invention, a method is provided for providing universal access to a service amongst a plurality of services comprising:
storing a plurality of service accounts, each corresponding to a customer and a service said customer is subscribed to,
receiving a request from a customer for using a service,
determining a service account upon identification of such customer and the requested service or its service provider,
consulting confidential service account content corresponding to said service account,
   characterized in that consulting said confidential service account content comprises real-time communicating with said service provider, said service provider providing real-time access to said confidential service account content.

A first advantage of consulting the confidential service account content in real-time communication with the service provider, wherein the service provider allows real-time access to the confidential service account content, is that confidential service account content does not need to be shared with or stored in the service account database. Only information needed for identification of the customer and the requested service or its service provider, is stored in the service account database such that privacy and security problems may be decreased or even minimized.

Another advantage is that service account content does not need to be duplicated from the service provider's database such that memory space may be saved.

A further advantage is that due to the real-time communication and real-time access, such method may have the ability to deliver the customer and the service provider up-to-date service account content.

In an embodiment of the present invention, identification of the customer may comprise hashing a customer's identification code from any available identification instrument such as a chip card, a magnetic strip card, an RFID card, an RFID tag, a telephone, a mobile phone, a Bluetooth device, a barcode, a Media Access Control (MAC) address, and the like. Used hash algorithms may be any algorithm used in the state of the art for encryption of identification codes. The customer can register multiple identification instruments at any time and link them to the same identification code, that identification can be done by hashing any available identification instrument of a number of identification instruments linked to said customer's identification code.

The advantage of hashing a customer's identification code from any available identification instrument is that no additional dedicated universal identification instrument has to be released and that a customer is not dependent on carrying that dedicated universal identification instrument with him every time he wants to make use of a service. A customer may be able to identify himself by an identification instrument of his choice, since only one identification code, in combination with the requested service or its service provider, is required for determination of the service account. Further, by linking his identification code to a number of identification instruments of his choice, it is sufficient that the customer has only one of these instruments available at the moment he intends to use a service.

A method in accordance with the present invention may further comprise associating said confidential service account content with another service account of said customer, such as a financial account. For example, upon consulting confidential service account information, a customer's financial account may be debited or credited to a more or less extend depending on that information.

In an embodiment in accordance with the present invention, the method may further comprise transmitting new confidential service account content to said service provider. When using a service by a customer, new confidential service account content may be generated which may be transmitted to the corresponding service provider, preferably on a real-time basis.

Additionally, in accordance with the present invention a system is provided for providing universal access to a service amongst a plurality of services comprising:
a means for storing a plurality of service accounts, each corresponding to a customer and a service said customer is subscribed to,
a determination means for determining a service account upon identification of such customer and the requested service or its service provider,
a consulting means for consulting confidential service account content corresponding to said service account,
   characterized in that said consulting means is adapted to communicate real-time with said service provider, said service provider providing real-time access to said confidential service account content.

A system in accordance with the present invention may further comprise an identification means for identifying said customer. Such identification means may comprise any kind of tool to read a customer's identification code from any identification instrument such as a chip card, a magnetic strip card, an RFID card, an RFID tag, a telephone, a mobile phone, a Bluetooth device, a barcode, a MAC-address, and the like. In particular, such identification means may be a service provider terminal connected to the provider's point-of-sale (POS), a chip card reader, a magnetic stripe card reader, a bar code reader, a Bluetooth receiver, and the like. Such identification means may be adapted for hashing any available identification instrument of a number of identification instruments linked to said customer's identification code.

The means for storing a plurality of service accounts (also called the service account database) and the consulting means may be hosted on a server, a web server, or a server in the cloud.

The determination means may be hosted on the server, the web server, the server in the cloud, or partially on the server or web server or server in the cloud and partially on the POS.

Besides the general advantage that a method and system in accordance with the present invention do not require anymore a specific identification instrument for each service account, even a dedicated identification instrument collecting a customer's identification codes for each service account he is subscribed to is not required. A customer may be able to identify himself by an identification instrument of his choice, since only one identification code, in combination with the requested service or its service provider, is required for determination of the service account. Further, by linking his identification code to a number of identification instruments of his choice, it is sufficient that the customer has only one of these instruments available at the moment he intends to use a service.

Further, in case the customer is a group of people, a number of customer identification codes belonging to the members of such group may be linked to the same service account. For example, employees employed in a company subscribed to a store's loyalty program, may be linked to the same loyalty program account, upon identifying themselves as individual person in such store.

Further, a method and system according to the present invention may provide one or a combination of functionalities such as business intelligence, segmented communication based on customer profiling, mystery shopping.

In a particular embodiment related to business intelligence, a method in accordance with the present invention may be provided wherein the step of consulting comprise communicating specific confidential service account content to parties other than the costumer and the service provider and being involved to the service. Such party other than the costumer or the service provider may be for example a manufacturer, an insurance company, etc.

Communicating specific confidential service account data may be provided at those parties by communication dashboards. For example, a system and method in accordance with the present invention may be used in a multi-role loyalty program, wherein each role, i.e. the costumer, the loyalty service provider, the manufacturer, etc., uses a communication dashboard for consulting role-specific confidential service account data.

By using communication dashboards for every party involved in the service, communication links may be provided, not only between consumer and service provider, but also between service provider and for example a manufacturer, or between the consumer and the manufacturer. Via his dedicated communication dashboard, each party may have the ability to manage the status of a particular service.

As written above, only information needed for identification of the customer and the requested service or its service provider is stored in the service account database, i.e. the service account database manages data streams between service providers, POS's, and consumers, but does not manage the database content of those service providers, POS's and consumers.

### Example 1

A consumer links the services he is subscribed to to his bank card of which the hash is stored in the service account database (SAD). Additionally, the costumer also stores the hash of his cell phone in the service account database.

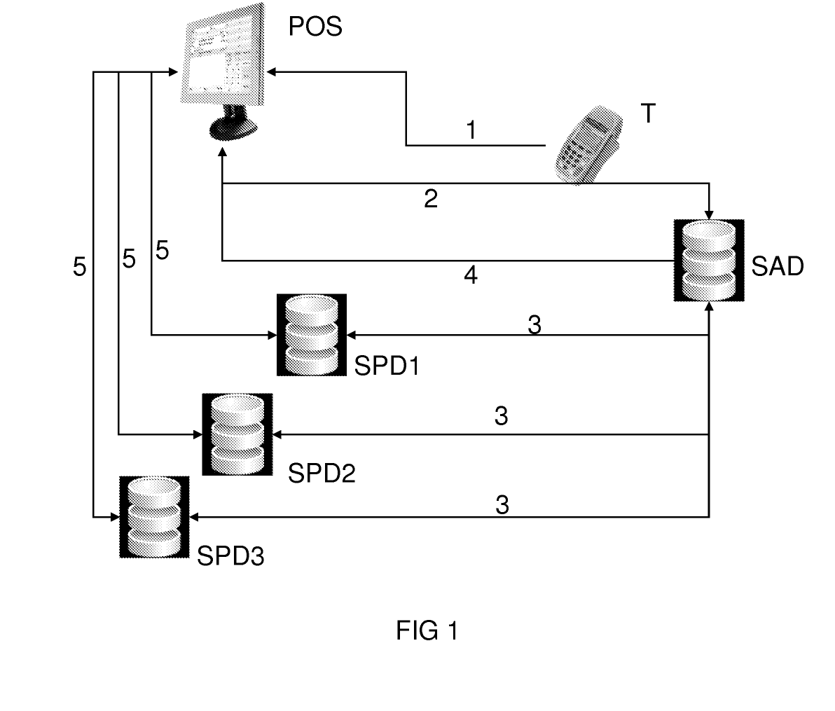

When the customer is at a service provider's premises, he identifies himself by means of his bank card or by his cell phone, whatever he has available at that moment. As illustrated in FIG. 1, the identification program on the service provider's point-of-sale (POS) or the bank card terminal (T) connected to it hashes the card or the cell phone (arrow 1) and queries the SAD (arrow 2). The determination program on the SAD recognizes the hash, and responds the corresponding service account in de SAD based on the identity of the customer and the origin of the query (arrow 2)

The SAD connects in real-time to the service provider's database (SPD1, 2, 3) and queries the confidential service account content it needs (arrow 3). The SAD provides the confidential service account content to the POS (arrow 4) and may visualize it via a visualization system on the POS (not shown). The POS settles and concludes the service with the corresponding SPD (arrow 5).

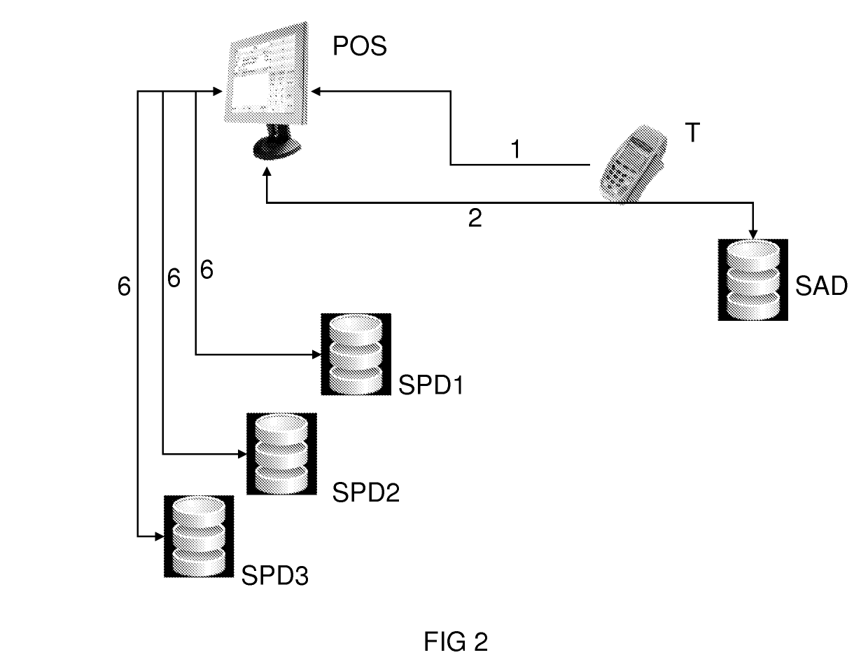

Alternatively and as shown in FIG. 2, upon receiving the corresponding service account (arrow 2), the POS directly queries the service provider's database (SPD1, 2, 3) for the confidential service account content it needs, settles and concludes the service with the corresponding SPD (arrow 6).

### Example 2

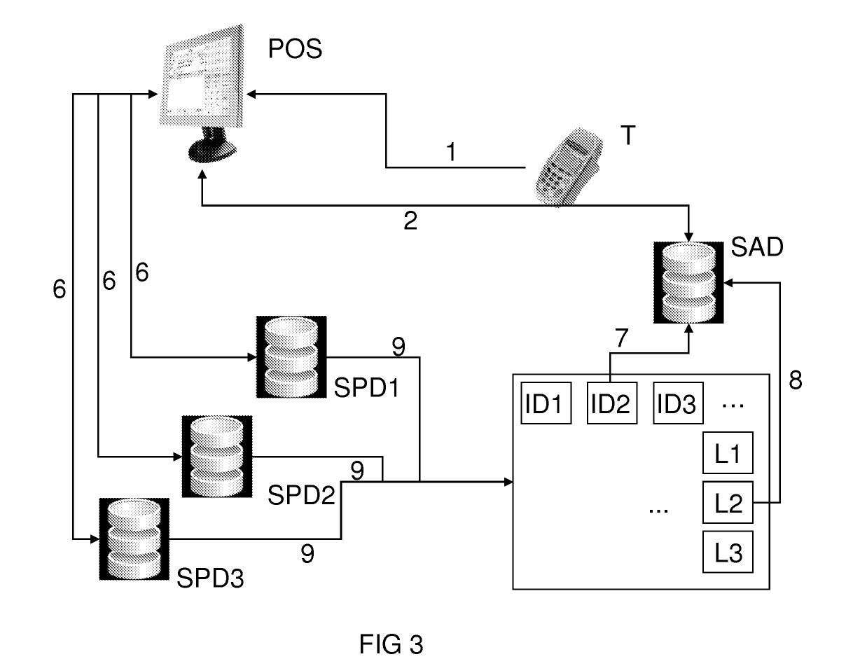

A multi-role loyalty program using a method or system according to the present invention is described below and illustrated in FIG. 3:

The first time a consumer uses his consumer dashboard he can register the identification means (ID1, ID2, ID3) of his choice. The consumer dashboard hashes those means. The hash is streamed to the SAD (arrow 7) and in the SAD the hashes are all linked to same consumer identification code.

Via his consumer dashboard a consumer is able to consult which service providers (SPD1, SPD2, SPD3), for example manufacturers, are linked to the system and provide a loyalty program. The consumer can subscribe to any of the provided loyalty programs (L1, L2, L3). The subscribed loyalty programs are stored in the SAD (arrow 8) and linked to the consumer identification code.

Upon identification at a POS with any available identification means, the service account corresponding to the consumer and the loyalty program he subscribed to is determined. The POS settles the service with the corresponding manufacturer's SPD.

Both at the POS and at the manufacturer's site, the communication dashboard is updated in real-time, such that the POS is informed that for example the stock of a product is decreasing and that the manufacturer is informed that a specific consumer has made use of his loyalty program. The SPD (manufacturer) can react immediately and can sent in real-time an additional loyalty, which the consumer can consult on his consumer dashboard (arrow 9).

1. A method for providing universal access to a service amongst a plurality of services comprising:
storing a plurality of service accounts, each corresponding to a customer and a service said customer is subscribed to,
receiving a request from a customer for using a service, and
determining a service account upon identifying such customer and the requested service or its service provider, consulting confidential service account content corresponding to said service account, said consulting comprising real-time communicating with said service provider, said service provider providing real-time access to said confidential service account content,
wherein identifying such customer comprises hashing any available identification instrument of a number of identification instruments linked to said customer's identification code.

2. The method for providing universal access to a service amongst a plurality of services according to claim 1, wherein identification of said customer comprises hashing a chip card, a magnetic strip card, an RFID card, an RFID tag, a telephone, a mobile phone, a Bluetooth device, a barcode, a MAC-address, and the like.

3. The method for providing universal access to a service amongst a plurality of services according to claim 1, further comprising associating said confidential service account content with a said customer's financial account.

4. The method for providing universal access to a service amongst a plurality of services according to claim 1, wherein said service is a banking service, a loyalty program, a warranty service, a rental service, a pre-payment service, a coupon service, a ticketing service, a health care service, a governmental service and the like.

5. The method for providing universal access to a service amongst a plurality of services according to claim 1, further comprising transmitting new confidential service account content to said service provider.

6. The method for providing universal access to a service amongst a plurality of services according to claim 1, wherein said consulting further comprises communicating specific confidential service account data via communication dashboards to parties other than said costumer and said service provider and being involved to the service.

7. The method according to claim 6, wherein said service is a multi-role loyalty program.

8. A system for providing universal access to a service amongst a plurality of services comprising:
a means for storing a plurality of service accounts, each corresponding to a customer and a service said customer is subscribed to,
a determination means for determining a service account upon identification of such customer and the requested service or its service provider,
an identification means for identifying said customer, and
a consulting means for consulting confidential service account content corresponding to said service account, said consulting means adapted to communicate real-time with said service provider, said service provider providing real-time access to said confidential service account content,
wherein said identification means are adapted for hashing any available identification instrument of a number of identification instruments linked to said customer's identification code.

9. The system for providing universal access to services according to claim 8, wherein said identification means comprises any kind of tool to read a customer's identification code from any identification instrument such as a chip card, a magnetic strip card, an RFID card, an RFID tag, a telephone, a mobile phone, a Bluetooth device, a barcode, a MAC-address, and the like.

10. The system for providing universal access to a service amongst a plurality of services according to claim 7, wherein said service is a banking service, a loyalty program, a warranty service, a rental service, a pre-payment service, a coupon service, a ticketing service, a health care service, a governmental service, and the like.

11. The system for providing universal access to a service amongst a plurality of services according to claim 8, wherein said consulting means comprise communication dashboards for providing role-specific confidential service account data.

12. The system for providing universal access to a service amongst a plurality of services according to claim 11, wherein said service is a multi-role loyalty program.

13. A multi-role loyalty program using a system for providing universal access according to claim 8.

14. The multi-role loyalty program using a method for providing universal access according to claim 1.

15. A multi-role loyalty program according to claim 13, wherein for each role a communication dashboard is provided.
